(19) United States
(12) Patent Application Publication
(10) Pub. No.: US 2016/0359399 A1
(43) Pub. Date: Dec. 8, 2016

(54) Hybrid Traction Motor Rotors for Diesel-Electric Locomotives

(71) Applicant: Electro-Motive Diesel, Inc., LaGrange, IL (US)

(72) Inventor: Thomas D. Spry, Sugar Grove, IL (US)

(73) Assignee: Electro-Motive Diesel, Inc., LaGrange, IL (US)

(21) Appl. No.: 14/729,828

(22) Filed: Jun. 3, 2015

(51) Int. Cl. H02K 17/16; B60L 11/02; B61C 7/04; H02K 9/02; H02K 15/02

(52) U.S. Cl. CPC H02K 17/165; H02K 9/02; H02K 15/02; B61C 7/04; B60L 11/02

(57) ABSTRACT

A traction motor may comprise a stator and a rotor rotatably mounted within the stator. The rotor may include a cylindrical core having a top surface, a bottom surface, and a plurality of receiving holes extending through the cylindrical core. The rotor may further include a plurality of copper bars each inserted in a respective one of the receiving holes of the cylindrical core and having terminal ends extending beyond the top surface and the bottom surface of the cylindrical core. The rotor may further include aluminum end rings cast around the terminal ends of the copper bars. The traction motor may have a size and power range suitable for use with a diesel-electric locomotive.

### TECHNICAL FIELD

The present disclosure generally relates to traction motors for diesel-electric locomotives and, more specifically, to traction motor rotors for diesel-electric locomotives formed from cost-effective metallic components.

### BACKGROUND

Diesel-electric locomotives use a diesel engine to drive an alternating current (AC) alternator or a direct current (DC) generator. The power output of the AC alternator or the DC generator is used to power traction motors that, in turn, provide propulsion power to the wheels to move the train. One traction motor may drive each axle of the locomotive through a gear drive. Specifically, each traction motor may drive the rotation of a small gear that meshes with a larger gear on the axle shaft to provide desired gear reduction.

Traction motors used in diesel-electric locomotives may be AC induction motors that include an annular stator inside of which a cylindrical rotor is rotatably provided. The rotor may include a plurality of conductive bars arranged along the length of the rotor in a “squirrel-cage” structure. The stator may include a ring of electromagnets that produce a rotating magnetic field when power is supplied to the stator, and the rotating magnetic field may lead to rotation of the rotor and the flow of current along the conductive bars of the rotor.

Rotors used in AC induction-type traction motors for diesel locomotives may also include metallic end rings that serve to mechanically restrain the conductive bars in the rotor as well as electrically connect the conductive bars. Current designs for such rotors may use copper bars as the conductive bars and copper end rings due to the favorable conductive properties of copper. In particular, the copper end rings may be brazed to the copper bars to mechanically fix the structure of the rotor. However, such rotor designs may have high manufacturing costs given the relative expense of copper compared with other metals, the use of expensive brazing materials such as silver braze alloys, and the sheer weight and number of traction motors needed for diesel-electric locomotive applications.

U.S. Pat. No. 8,701,270 discloses squirrel-cage rotors having aluminum-based end rings joined with copper bars for electric motors. In particular, the aluminum-based end rings are joined to the copper bars by a casting process, and the ends of the copper bars joined to the end rings are coated with an aluminum alloy to reduce the electrical resistance between the copper bars and the aluminum end rings. While effective, further improvements in traction motor rotor designs applicable to diesel-electric locomotive applications are still wanting.

Clearly, there is a need for improved designs for traction motor rotors for diesel-electric locomotive applications.

### SUMMARY

In accordance with one aspect of the present disclosure, a traction motor is disclosed. The fraction motor may comprise a stator and a rotor rotatably mounted within the stator. The rotor may include a cylindrical core having a top surface, a bottom surface, and a plurality of receiving holes extending through the cylindrical core. The rotor may also include a plurality of copper bars each inserted in a respective one of the receiving holes of the cylindrical core. The copper bars may have terminal ends projecting beyond the top surface and the bottom surface of the cylindrical core. In addition, the rotor may further include aluminum end rings cast around the terminal ends of the copper bars. The traction motor may have a size and a power range suitable for use with a diesel-electric locomotive.

In accordance with another aspect of the present disclosure, a diesel-electric motor is disclosed. The diesel-electric motor may comprise a diesel engine, an alternator powered by the diesel engine, a plurality of wheels operatively associated with the diesel engine and the alternator, and a plurality of axles driving a rotation of the wheels. The diesel-electric locomotive may further include traction motors powered by the alternator and configured to drive rotation of the axles. Each of the traction motors may be associated with a respective one of the axles and may include a stator and a rotor inside of the stator. The rotor may include a cylindrical core having a central hole and a plurality of receiving holes arranged circumferentially about the central hole, and a plurality of copper bars each inserted in a respective one of the receiving holes. The copper bars may have first and second terminal ends extending out from opposing ends of the cylindrical core. The rotor may further include an aluminum end ring cast around each of the first and second terminal ends of the copper bars.

In accordance with another aspect of the present invention, a method of fabricating a fraction motor rotor for a diesel-electric locomotive is disclosed. The method may comprise forming a plurality of copper bars, and assembling the plurality of copper bars with a cylindrical core by inserting each of the plurality of copper bars in an axially-extending receiving hole of the cylindrical core such that terminal ends of the copper bars extend from opposing ends of the cylindrical core. The method may further comprise casting aluminum end rings around the terminal ends of the copper bars to provide the fraction motor rotor.

These and other aspects and features of the present disclosure will be more readily understood when read in conjunction with the accompanying drawings.

### BRIEF DESCRIPTION OF THE DRAWINGS

FIG. 1 is schematic representation of a diesel-electric locomotive, in accordance with the present disclosure.

FIG. 2 is a cross-sectional view of a traction motor of the diesel-electric locomotive engaged with an axle, constructed in accordance with the present disclosure.

FIG. 3 is a perspective view of a rotor of the traction motor of FIG. 2 shown in isolation, constructed in accordance with the present disclosure.

FIG. 4 is a perspective view of a cylindrical core of the rotor of FIG. 3 shown in isolation, constructed in accordance with the present disclosure.

FIG. 5 is a side view of the cylindrical core assembled with copper bars, constructed in accordance with the present disclosure.

FIG. 6 is a side view of the rotor after casting aluminum end rings around the terminal ends of the copper bars, constructed in accordance with the present disclosure.

FIG. 7 is a side view similar to FIG. 6 but having cooling fins projecting from a top surface of one of the aluminum end rings, constructed in accordance with the present disclosure.

FIG. 8 is a top view of the rotor of FIG. 7, constructed in accordance with the present disclosure.

FIG. 9 is a flowchart of a series of steps that may be involved in fabricating the rotor, in accordance with a method of the present disclosure.

### DETAILED DESCRIPTION

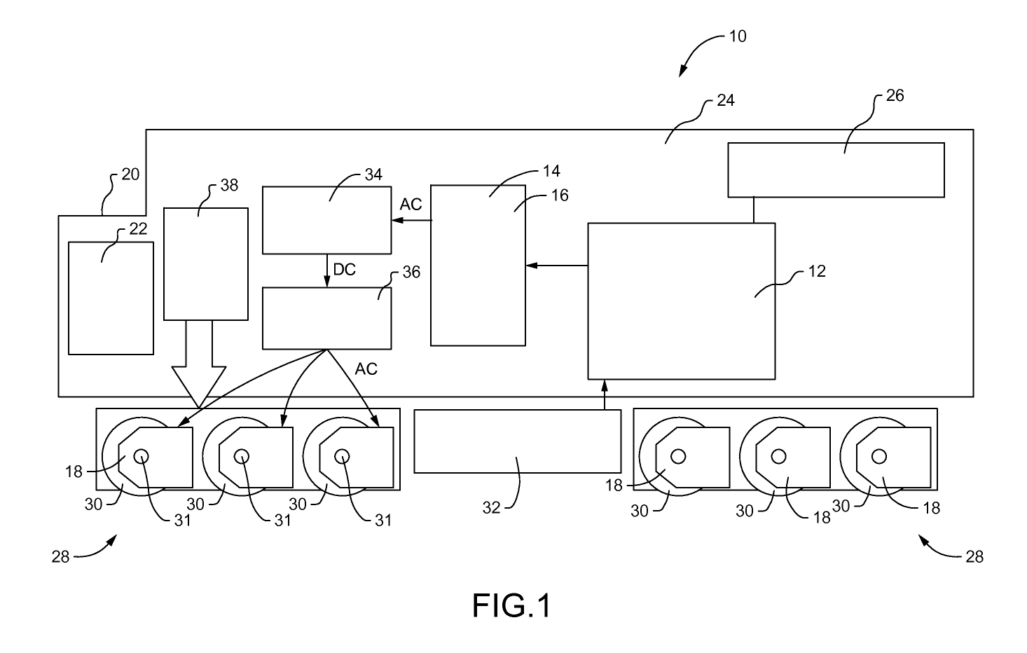

Referring now to the drawings, and with specific reference to FIG. 1, a diesel-electric locomotive 10 is shown. The locomotive 10 may provide motive power to a train and may be powered by a combination of a diesel fuel-burning internal combustion engine 12 (the prime mover), a generator 14 such as an alternating current (AC) alternator 16 or a DC generator, and traction motors 18, as will be described in further detail below. The diesel-electric locomotive 10 may generally include an operator cab 20 with a control stand 22, a car body 24 carrying the diesel engine 12 and a radiator 26, and trucks 28 which may include wheels 30, axles 31 configured to drive the rotation of the wheels 30, and a traction motor 18 associated with each axle 31. For example, the car body 24 may include six axles 31 with six traction motors 18 to drive the rotation of the axles, although other numbers of axles and traction motors are certainly possible. For example, in some arrangements, the locomotive 10 may include four or eight traction motors 18 each associated with an axle 31.

In operation, a fuel tank 32 may provide diesel fuel to the engine 12 and the engine 12 may combust the diesel fuel. The AC alternator 16 may convert the mechanical energy produced from the combustion in the engine 12 into electrical energy in the form of alternating current (AC). A rectifier 34 may convert the AC produced by the AC alternator 16 into direct current (DC), and an inverter 36 may convert the DC from the rectifier 34 to AC used to power the traction motors 18. When powered by the AC, the traction motors 18 may drive the rotation of its associated axle 31 to cause the rotation of the wheels 30. In particular, each traction motor 18 may drive the rotation of a small gear (not shown) that meshes with a larger gear (not shown) on the axle shaft to provide speed reduction at the wheels 30. As heat is liberated at the traction motors 18 during operation, a blower 38 may blow cooling air on the traction motors 18.

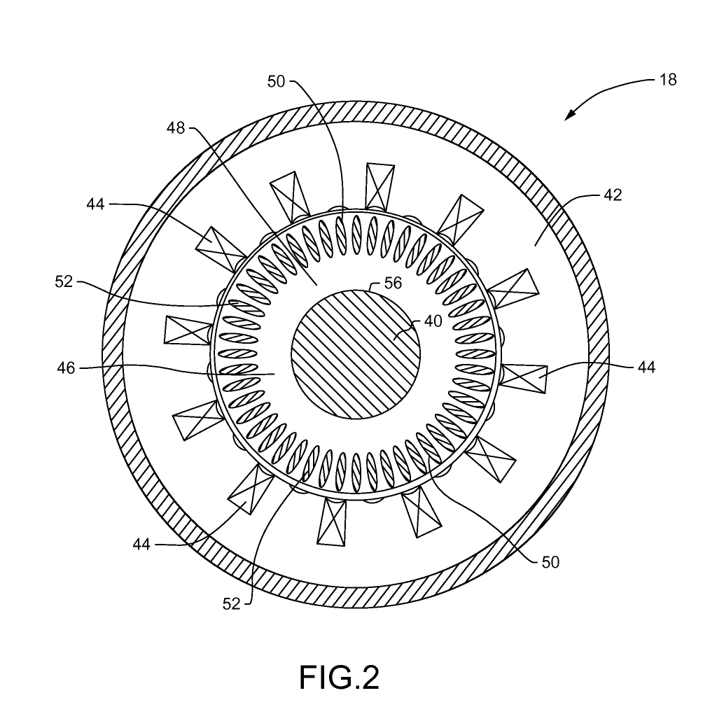

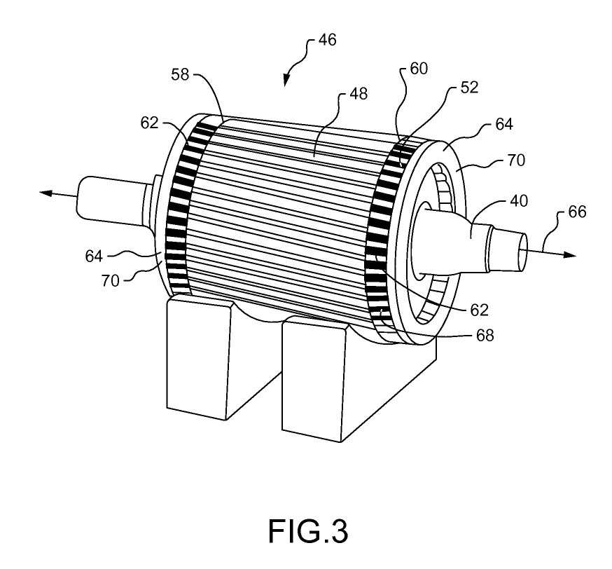

Turning now to FIG. 2, the traction motor 18 engaged with a shaft 40 is shown in isolation. The traction motor 18 may be an AC induction motor and may include a stationary stator 42 which may have a ring of electromagnets 44 distributed annularly about the stator 42. A rotor 46 may be rotatably mounted within and located radially inside of the stator 42, as shown. The rotor 46 may be a “squirrel-cage” type of rotor and may include a cylindrical core 48 having a plurality of receiving holes 50 configured to receive straight conductive bars 52. The receiving holes 50 may be evenly distributed annularly about a peripheral edge 54 of the cylindrical core 48 and may extend along an axial length of the core 48, such that the conductive bars 52 create the “squirrel-cage” structure when assembled with the cylindrical core 48 (also see FIG. 3). The cylindrical core 48 may also include a central hole 56 that may receive the shaft 40 which may be coupled to, or part of, the axle 31.

Although well understood by those with ordinary skill in the art, the general operation of the fraction motor 18 will now be described. When AC from the AC alternator 16 passes through the stator 42, a rotating magnetic field may be produced by the electromagnets 44 in the stator 42. An induced magnetic field in the rotor 46 may be attracted to and may follow the rotation of the rotating magnetic field of the stator 42. The relative motion between the rotating magnetic field of the stator 42 and the rotation of the rotor 46 may induce an electric current in the conductive bars 52 which leads to a force sufficient to turn the shaft 40.

The traction motor 18 disclosed herein has a physical size and power range suitable for diesel-electric locomotive applications. In contrast to fraction motors for hybrid automobiles which may provide power in a range of about 50 to 60 horsepower, the traction motor 18 disclosed herein may be capable of providing power in a range of about 700 to about 1000 horsepower. In addition, the traction motor 18 disclosed herein may be several times larger than a traction motor for a hybrid automobile, and may weigh about 2000 pounds or more.

FIG. 3 shows the rotor 46 of the traction motor 18 in isolation. As can be seen from FIG. 3, the cylindrical core 48 may include a top surface 58 and a bottom surface 60, and the conductive bars 52 may have terminal ends 62 that project from both the top surface 58 and the bottom surface 60 (also see FIG. 5). The terminal ends 62 of the conductive bars 52 may be straight, or they may be bent and joined together such as by welding or brazing. The rotor 46 may also include end rings 64 attached by brazing to the terminal ends 62 of the conductive bars 52, with one end ring 64 attached to the terminal ends 62 extending from the top surface 58 and another attached to the terminal ends 62 extending from the bottom surface 60. The end rings 64 may serve to mechanically restrain the conductive bars 52 as well as provide electrical connectivity between the conductive bars 52. In this regard, the end rings 64 may also be formed from a conductive material. The conductive bars 52 may be oriented parallel to a rotor axis 66, or they may be considerably or slightly skewed along the length of the rotor 46 with respect to the rotor axis 66 as shown in FIG. 3. As such, the receiving holes 50 of the cylindrical core 48 may also be skewed along the length of the rotor 46 with respect to the rotor axis 66.

The conductive bars 52 of the rotor 46 may be copper bars 68 due to the superior conductive properties of copper. The copper bars 68 may be formed from pure copper or a copper alloy. Moreover, the end rings 64 may be aluminum end rings 70 that are cast around the terminal ends 62 of the copper bars 68. The aluminum end rings 70 may be formed from pure aluminum or an aluminum alloy. The aluminum end rings 70 may have a good conductivity match with the copper bars 68 to promote current flow therebetween. The terminal ends 62 of the copper bars 68 may optionally be cleaned by dipping in a mild aqueous acid solution to remove oxides and contaminants and allow the molten aluminum to wet and thoroughly contact the terminal ends 62 to promote current flow therebetween. A liquid, slurry, or paste flux may optionally be applied to terminal ends 62 of the copper bars 68 by brushing or dipping before initiation of the casting process, to further clean the surface of the copper bars 68 during the casting process and promote current flow between the aluminum end rings 70 and the copper bars 68. As used herein, a flux is an aqueous chemical solution in liquid, slurry, or paste form, applied to the surface of the terminal ends 62 of copper bars 68. When exposed to the heat of the casting process, flux may remove and prevent reformation of surface oxides on the copper, and may allow the molten aluminum to wet and thoroughly contact the terminal ends 62 of the copper bars 68 to promote current flow therebetween. The use of aluminum end rings as opposed to copper end rings of the prior art may substantially cut down on manufacturing costs of the rotor 46 due to the higher cost of copper. In addition, the use of cast aluminum end rings may also reduce manufacturing costs by eliminating the need for expensive brazing materials used to braze copper end rings to copper bars as is currently used for the manufacture of traction motor rotors for diesel-electric locomotives. Even further, the use of the aluminum end rings 70 may also provide advantageous weight reductions compared with copper end rings of the prior art, as aluminum is lighter in weight than copper.

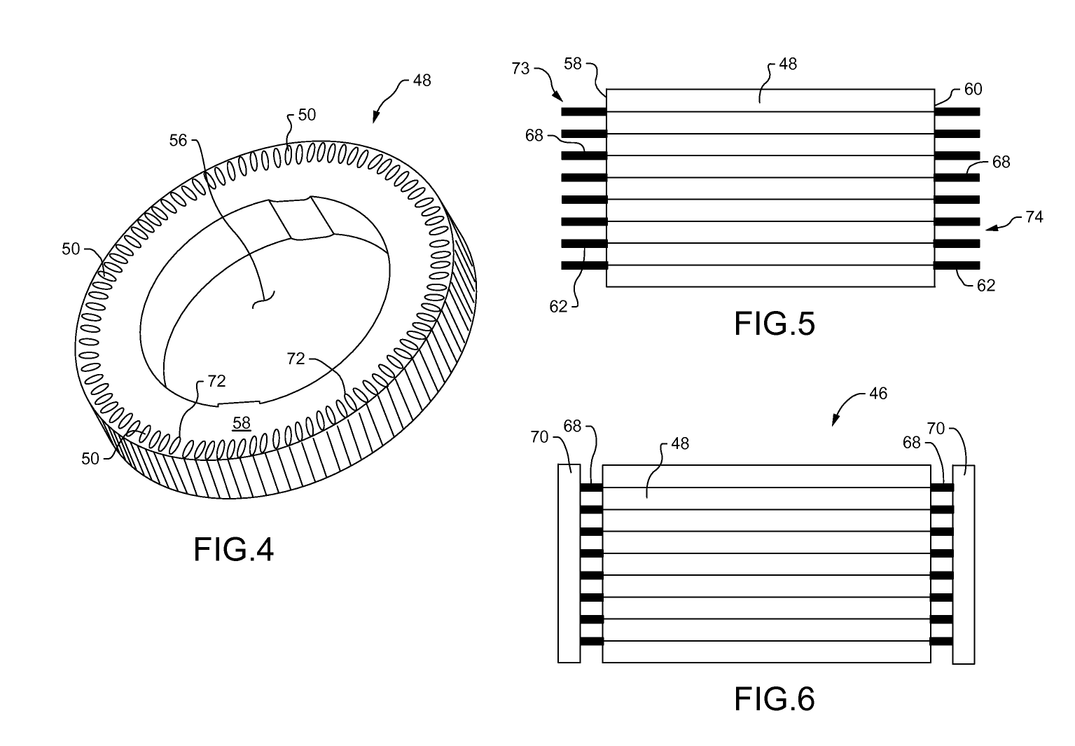

Turning now to FIG. 4, the cylindrical core 48 is shown in isolation. The cylindrical core 48 may consist of a plurality of stacked laminated steel plates that are coated with an insulating material. Each of the laminated steel plates may have identical notches 72 formed along the outer periphery of the plates such that when the plates are stacked and aligned, the aligned notches 72 of the plates form the receiving holes 50 along the length of the rotor 46. The copper bars 68 may be inserted through the receiving holes 50 to restrain the stacked steel plates in a cylindrical structure.

When assembled with the cylindrical core 48, the terminal ends 62 the copper bars 68 may project beyond the top surface 58 and the bottom surface 60 of the cylindrical core 48, as shown in FIG. 5. Specifically, first terminal ends 73 of the copper bars 68 may project from the top surface 58, while second terminal ends 74 may project from the bottom surface 60. In some cases, the terminal ends 62 may be bent and joined to provide electrical connectivity between the bars 68, in which case the aluminum end rings 70 may provide further electrical connection between the bars 68. If the terminal ends 62 of the copper bars 68 are straight and unconnected as shown in FIG. 5, the electrical connectivity between the bars 68 may only be provided by the aluminum end rings 70.

Referring now to FIG. 6, the aluminum end rings 70 may be cast around the first and second terminal ends 73 and 74 of the copper bars 68 to mechanically attach the copper bars 68 to the aluminum end rings 70. The terminal ends 62 may be non-coated and may form a direct contact with the aluminum end rings 70. The terminal ends 62 may optionally be cleaned by dipping in a mild aqueous acid solution to remove oxides and allow the molten aluminum to wet and thoroughly contact the terminal ends 62 to promote current flow therebetween. A flux may optionally be applied to the terminal ends 62 before initiation of the casting process as an aid to cleaning of the surface of the terminal ends 62 during the casting process and promote current flow between the aluminum end rings 70 and the copper bars 68. The casting process may involve placing the assembled cylindrical core 48 and the copper bars 68 (see FIG. 5) in one or more molds configured to shape the two aluminum end rings 70. Specifically, the first terminal ends 73 may be placed in one cavity of the mold that shapes one of the end rings 70, and the second terminal ends 74 may be placed in another cavity of the mold that shapes the other end ring 70. Molten aluminum or a molten aluminum alloy may then be poured by gravity or supplied under pressure into the cavities of the mold and may be allowed to solidify to provide the aluminum end rings 70 attached to the copper bars 68.

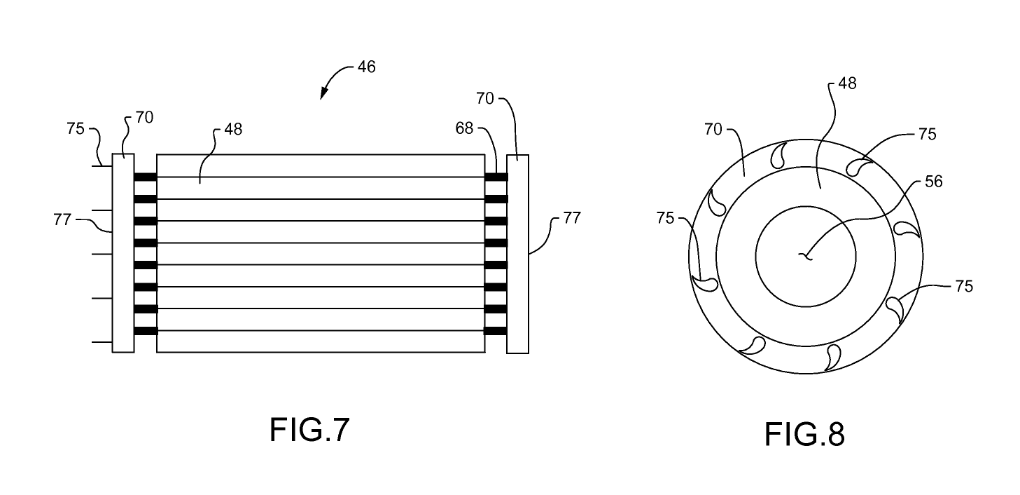

If desired, additional features may be integrally molded with the aluminum end rings 70. For example, cooling fins 75 may be integrally molded with one or both of the aluminum end rings 70 such that the cooling fins 75 protrude from a top surface 77 of the aluminum end ring 70, as shown in FIGS. 7-8. The cooling fins 75 may assist in cooling the traction motor 18 as the rotor 46 rotates. This is yet another advantage of the cast aluminum end rings 70 as the casting process may provide direct access to additional integrally molded features, such as the cooling fins 75.

### INDUSTRIAL APPLICABILITY

The teachings of the present disclosure may find industrial applicability in a variety of settings such as, but not limited to, diesel-electric locomotive applications. The traction motor disclosed herein is sized for use in diesel-electric locomotive applications and includes a rotor having copper bars joined with cast aluminum end rings.

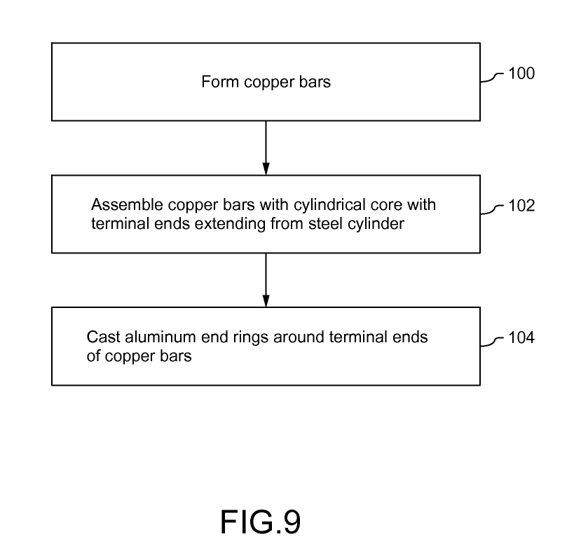

A series of steps that may be involved in the fabrication of the fraction motor rotor 46 of the present disclosure is shown in FIG. 9. Beginning with a first block 100, the copper bars 68 may be formed by various methods such as, but not limited to, extrusion, casting, forging, and powder metallurgy. Alternatively, the copper bars 68 may be formed inside of the receiving holes 50 of the cylindrical core 48 such as by casting or powder metallurgy. As another alternative, the copper bars 68 may be obtained commercially. If formed outside of the cylindrical core 48, the copper bars 68 may then be assembled with the cylindrical core 48 according to a next block 102. In particular, each of the copper bars 68 may be inserted in a respective one of the receiving holes 50 of the cylindrical core 48 such that the terminal ends 62 of the copper bars 68 extend out from opposing ends (i.e, the top surface 58 and the bottom surface 60) of the cylindrical core 48, as best shown in FIG. 5. Optionally, the terminal ends 62 may then be connected together by bending the terminal ends 62 towards each other and joining them by a suitable process, such as welding or brazing. Otherwise, the terminal ends 62 may remain disconnected and straight as shown in FIG. 5.

According to a next block 104, the aluminum end rings 70 may be cast around terminal ends 62 of the copper bars 68 such that an aluminum end ring 70 is formed above each of the top surface 58 and the bottom surface 60 of the cylindrical core 48 as shown in FIG. 6. The block 104 may be achieved by optionally dipping the terminal ends 62 in a mild acid to remove oxides, by optionally applying a flux to the terminal ends 62 of the copper bars 68, by placing the terminal ends 62 of the copper bars 68 in a mold in a shape of the aluminum end rings 70, pouring molten aluminum or a molten aluminum alloy into the mold, and allowing the molten aluminum or aluminum alloy to solidify. Optionally, the block 104 may be carried out at a pressure above atmospheric pressure to enhance the soundness and strength of the resulting aluminum end rings 70. In addition, the cooling fins 75 or other structural features may be integrally molded on one or both of the aluminum end rings 70 during the block 104 if desired. Once formed, the traction motor rotor 46 may be assembled with the stator 42 to provide the traction motor 18, as will be well understood by those with ordinary skill in the art.

The use of cast aluminum end rings in the traction motor rotor as opposed to copper end rings of the prior art may lead to advantageous reductions in manufacturing costs, as copper is significantly more expensive than aluminum. In addition, the use of cast aluminum end rings may further reduce costs by eliminating the need for expensive brazing materials to attach copper end rings to copper bars, as is currently used in prior art systems. The magnitude of cost savings in diesel-electric locomotive applications may be far greater than hybrid automobile applications given the much greater size and number of traction motors needed for diesel-electric locomotive applications. For example, a hybrid automobile may have two traction motors, whereas a diesel-electric train may have four, six, or eight traction motors on each freight locomotive. Moreover, the traction motor in a hybrid automobile may be much smaller and have a lower power range than a traction motor in a diesel-electric locomotive. The technology disclosed herein may find wide industrial applicability in a wide range of areas such as, but not limited to, diesel-electric locomotive applications, appliances, and various industrial applications.

WHAT IS CLAIMED IS:

1. A traction motor, comprising:
a stator; and
a rotor rotatably mounted within the stator and including
a cylindrical core having a plurality of receiving holes extending therethrough, the cylindrical core having a top surface and a bottom surface,
a plurality of copper bars, each of the copper bars inserted in a respective one of the receiving holes of the cylindrical core and having terminal ends projecting beyond the top surface and the bottom surface of the cylindrical core, and
aluminum end rings cast around the terminal ends of the copper bars, the fraction motor having a size and power range suitable for use with a diesel-electric locomotive.

2. The traction motor of claim 1, wherein the traction motor is capable of providing power in a range of between about 700 horsepower to about 1000 horsepower.

3. The traction motor of claim 2, wherein the traction motor weighs about two thousand pounds.

4. The traction motor of claim 1, wherein the copper bars are uncoated, optionally cleaned by dipping in a mild acid, or a flux is optionally applied by brushing or dipping prior to casting, and wherein the copper bars form a direct contact with the aluminum end rings.

5. The traction motor of claim 1, wherein each of the aluminum end rings include a top surface, and wherein at least one of the aluminum end rings includes cooling fins extending from the top surface.

6. The traction motor of claim 4, wherein the cooling fins are integrally cast with the aluminum end ring.

7. The traction motor of claim 1, wherein the cylindrical core comprises a plurality of stacked laminated steel plates.

8. The traction motor of claim 1, wherein the traction motor is an AC induction motor.

9. A diesel-electric locomotive, comprising:
a diesel engine;
an alternator powered by the diesel engine;
a plurality of wheels operatively associated with the diesel engine and the alternator;
a plurality of axles driving a rotation of the wheels;
traction motors powered by the alternator and configured to drive rotation of the axles, each of the traction motors associated with a respective one of the axles and including
a stator, and
a rotor inside of the stator and including
a cylindrical core having a central hole and plurality of receiving holes arranged circumferentially about the central hole,
a plurality of copper bars each inserted in a respective one of the receiving holes of the cylindrical core and having first and second terminal ends extending out from opposing ends of the cylindrical core, and
an aluminum end ring cast around each of the first and second terminal ends of the copper bars.

10. The diesel-electric locomotive of claim 9, wherein the each of the traction motors is capable of providing power in a range of between about 700 horsepower to about 1000 horsepower.

11. The diesel-electric locomotive of claim 9, wherein each of the traction motors weighs about two thousand pounds.

12. The diesel-electric locomotive of claim 9, wherein the diesel-electric locomotive includes six axles and six traction motors each associated with a respective one of the six axles.

13. The diesel-electric locomotive of claim 9, wherein at least one of the aluminum end rings includes integrally cast cooling fins.

14. The diesel-electric locomotive of claim 13, wherein the integrally cast cooling fins extend from a top surface of the cast aluminum end ring.

15. The diesel-electric locomotive of claim 9, wherein the first and second terminal ends of the copper bars are uncoated and form a direct contact with the aluminum end rings.

16. The diesel-electric locomotive of claim 9, wherein electrical current flows between the copper bars and the aluminum end rings during operation of the traction motor.

17. A method of fabricating a traction motor rotor for a diesel-electric locomotive, comprising:
forming a plurality of copper bars;
assembling the plurality of the copper bars with a cylindrical core by inserting each of the plurality of copper bars in an axially-extending receiving hole of the cylindrical core such that terminal ends of the copper bars extend from opposing ends of the cylindrical core; and
casting aluminum end rings around the terminal ends of the copper bars to provide the fraction motor rotor.

18. The method of claim 17, wherein casting the aluminum end rings around the terminal ends of the copper bars comprises:
placing the terminal ends of the copper bars in a mold in a shape of the aluminum end rings;
pouring molten aluminum or aluminum alloy into the mold; and
allowing the molten aluminum or aluminum alloy to solidify.

19. The method of claim 18, wherein casting the aluminum end ring around each of the terminal ends of the copper bars is performed above atmospheric pressure.

20. The method of claim 18, wherein casting the aluminum end ring around each of the terminal ends of the copper bars further comprises casting integrally molded cooling fins on at least one of the aluminum end rings.
